(19) United States
(12) Patent Application Publication
(10) Pub. No.: US 2016/0171858 A1
(43) Pub. Date: Jun. 16, 2016

(54) ALARM SYSTEMS FOR DETECTING AND COMMUNICATING ANOMALOUS EVENTS

(71) Applicant: Jonas Patrik Trumphy, Solna (SE)

(72) Inventor: Jonas Patrik TRUMPHY, Solna (SE)

(21) Appl. No.: 14/965,524

(22) Filed: Dec. 10, 2015

(30) Foreign Application Priority Data
Dec. 10, 2014 (SE) 1451507-6

(51) Int. Cl. G08B 17/10; G08B 25/01

(52) U.S. Cl. CPC G08B 17/10; G08B 25/016

(57) ABSTRACT

The present invention relates to an alarm system comprising a cellular communication device, such as a smartphone/unit, and at least two detection arrangements, each detection arrangement, of the at least two detection arrangements, comprising: a housing; a detector device arranged in said housing, said detector device comprising a smoke detector and a gas detector and a moisture detector; a positioning device arranged in said housing; a control unit arranged in said housing; and a wireless communication device arranged in said housing; wherein said detector device being configured to provide said control unit with an indication of when smoke or gas or moisture has been detected, said positioning device being configured to provide said control unit with a geographical position of said detection arrangement, and said control unit being configured to transmit a message wirelessly through said wireless communication device to said cellular communication device after receiving an indication from said detector device when smoke or gas or moisture has been detected thereof, wherein said message comprises said geographical position and information of what has been detected; wherein each detection arrangement is arranged to monitor an area different from areas monitored by other detection arrangements; and said cellular communication device is configured to receive said alarm message transmitted from a detection arrangement and to notify a user of said cellular communication device of said alarm message.

### TECHNICAL FIELD

The present invention relates to an alarm system for monitoring of smoke and gas and moisture in a monitored area.

### BACKGROUND

The use of smoke alarms is a good way to reduce the effect a fire may cause, by making it possible to detect a fire as early as possible.

A typical smoke alarm has a smoke detector configured to monitor an area and to sound an alarm when smoke is detected in that area.

### SUMMARY

Similarly to monitoring an area regarding smoke, gas and moisture may additionally be monitored.

On object of the present invention is to improve monitoring of smoke and gas and moisture.

This object is according to the present invention attained by an alarm system as defined by the appended claims.

An alarm system for monitoring smoke, gas and moisture in a monitored area is presented. The alarm system comprises a cellular communication device, such as a smartphone/unit, and at least two detection arrangements. Each detection arrangement, of the at least two detection arrangements, comprises: a housing; a detector device arranged in the housing, the detector device comprising a smoke detector and a gas detector and a moisture detector; a positioning device arranged in the housing; a control unit arranged in the housing; and a wireless communication device arranged in the housing; wherein the detector device being configured to provide the control unit with an indication of when smoke or gas or moisture has been detected, the positioning device being configured to provide the control unit with a geographical position of the detection arrangement, and the control unit being configured to transmit a message wirelessly through the wireless communication device to the cellular communication device after receiving an indication from the detector device when smoke or gas or moisture has been detected thereof, wherein the message comprises the geographical position and information of what has been detected; wherein each detection arrangement is arranged to monitor an area different from areas monitored by other detection arrangements; and the cellular communication device is configured to receive the alarm message transmitted from a detection arrangement and to notify a user of the cellular communication device of the alarm message. In this way a detection arrangement may easily be moved between different areas to be monitored, and a recipient of an alarm message may easily identify the geographical position of the alarm.

The detector device preferably comprises a smoke sensor, a gas sensor and a moisture sensor.

The positioning device, in one embodiment, comprises a Global Positioning System (GPS) receiver, a Global Navigation Satellite System (GLONASS) receiver, a Galileo Positioning System receiver, an Indian Regional Navigation Satellite System receiver or a Beidou Navigation Satellite System receiver.

The control unit preferably comprises a processor and a memory.

The detection arrangement, in one embodiment, further comprises a siren device arranged in the housing, wherein the control unit further being configured to sound an alarm in the monitored area through the siren device after receiving an indication from the detector device when smoke and/or gas and/or moisture has been detected thereof, wherein the siren device preferably comprises a speaker for sounding the alarm.

The wireless communication device comprises in one embodiment a transceiver for a cellular or mobile network.

In one embodiment the control unit further being configured to wirelessly receive an indication of detected smoke, gas or moisture from another detection arrangement monitoring a different area, wherein the control unit preferably further being configured to sound an alarm in the monitored area through the siren device after receiving an indication of detected smoke, gas or moisture from the another detection arrangement monitoring a different area.

The message, in one embodiment, further comprises an identification of the detection arrangement.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 is a schematic diagram of a cellular network with two detection arrangements according to an embodiment of the present invention.

FIG. 2 is a flowchart illustrating a method of an embodiment of the present invention.

FIG. 3 is a schematic diagram of the components of a detection arrangement according to an embodiment of the present invention.

FIG. 4 is a schematic diagram illustrating functional modules of a detection arrangement presented herein.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

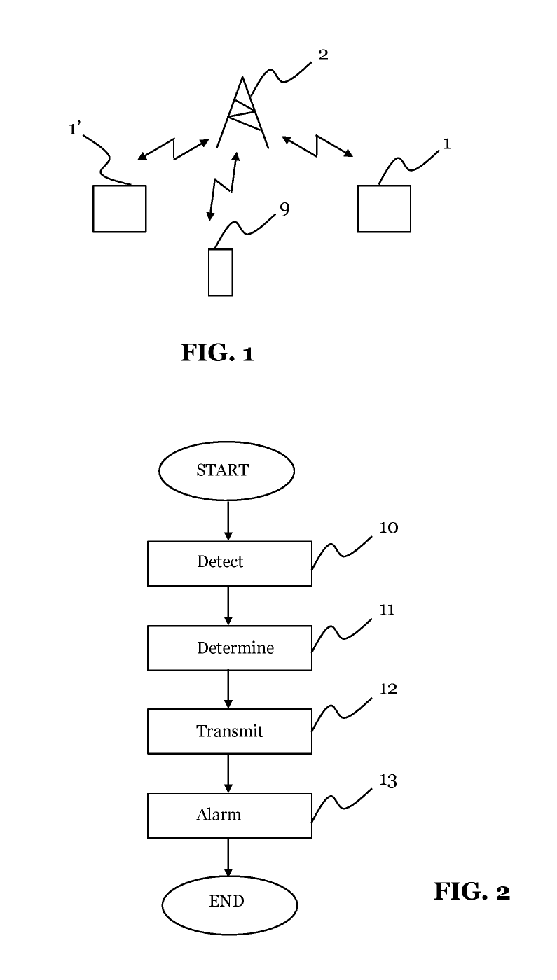

An alarm system for monitoring smoke, gas and moisture according to an embodiment of the present invention will now be described with reference to FIGS. 1-4.

The alarm system comprises at least two detection arrangements 1 and 1′, and a cellular communication device 9, such as a smartphone/unit.

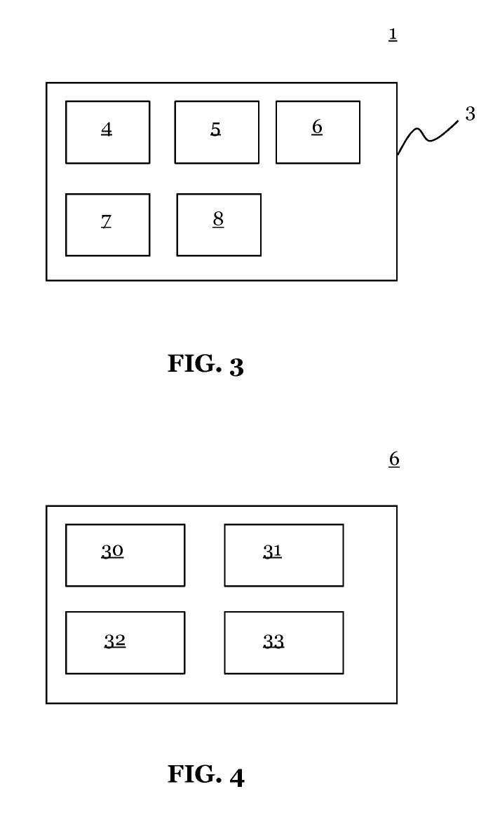

The detection arrangement 1, functionally illustrated in FIG. 3, comprises a housing 3. A detector device 4 is arranged in the housing, and the detector device 4 comprises a smoke detector and a gas detector and a moisture detector. A positioning device 5 is also arranged in the housing. The housing further houses a control unit 6 and a wireless communication device 7.

The detector device 4 being configured to provide the control unit 6 with an indication of when smoke and/or gas and/or moisture have been detected. The positioning device 5 being configured to provide the control unit 6 with a geographical position of the detection arrangement 1. The control unit 6 being configured to transmit a message wirelessly through the wireless communication device 7 after receiving an indication from the detector device 4 when smoke and/or gas and/or moisture has been detected thereof. The message comprises the geographical position of the detection arrangement 1 and information of what has been detected, i.e. smoke, gas or moisture.

The detector device 4 may comprise a smoke sensor, a gas sensor and a moisture sensor, which respectively may be a standard sensor. Within the housing 3 the detector device 5 may comprise a single multi-sensor or a separate sensor for each object being monitored. The detector device 4 may further comprise a temperature detector for detecting e.g. destructively low temperature.

The positioning device 5 may comprise one or more of the following receivers: a Global Positioning System (GPS) receiver, a Global Navigation Satellite System (GLONASS) receiver, a Galileo Positioning System receiver, an Indian Regional Navigation Satellite System receiver or a Beidou

Navigation Satellite System receiver. A geographical position may further be provided through cellular triangulation.

The detection arrangement 1 is by being provided with a wireless communication device 7 and a positioning device 5 being suitable for easy repositioning. The same detection arrangement 1 may e.g. at one time be positioned in a home, and at another time be positioned in a caravan, a boat, a summer house, or a mobile home. By being able to send an alarm message wirelessly from another position of the detection arrangement 1, i.e. monitoring of another area, that another position is easily identified by inclusion of a geographical position in the message. Two or more detection arrangements may thus provide a possibility to monitor property/neighbors/farms/companies in a simple way.

The message may be sent to the smartphone/unit 9, to provide a user of a detection arrangement with an indication that smoke/gas/moisture has been detected at the detection arrangement. Smoke typically indicates that a fire may be ongoing. Gas may be present due to a gas leakage, which provides an explosion risk, but may also be a sleeping gas fed into a vehicle for robbery. Moisture may be present due to a water leakage. The message may be used as report for the receiver only, but the receiver may further be configured to automatically relay the message to a fire department. Further, the detection arrangement may be configured to send an alarm message directly to a fire department.

The alarm message may e.g. be in the form of an SMS, a cellular call, or update of an application program.

The control unit 6 preferably comprises a processor and a memory. The memory may be used to store a control program for the detection arrangement 1, but may further also be used to store collected sensor data and/or information relevant to be sent in connection with an alarm message.

The detection arrangement 1 may further comprise a siren device 8 arranged in the housing 3. The control unit 6 then further being configured to sound an alarm in the monitored area through the siren device 8 after receiving an indication from the detector device 4 when smoke and/or gas and/or moisture has been detected thereof. The siren device 8 preferably comprises a speaker for sounding the alarm. The alarm may be configured in a form as a high intensity sound, a speaking informative voice, or a combination thereof.

The wireless communication device 7 is usable in a wireless network and may comprise a transceiver for a cellular network or mobile network, such as for Global System for Mobile Communications (GSM), for Personal Communications Service (PCS), and/or for Digital Advanced Mobile Phone Service (D-AMPS).

In FIG. 1 it is illustrated how two different detection arrangements 1 and 1′ communicate wirelessly with each other through a cellular or mobile network 2 to a smartphone/unit 9.

The control unit 6 of the detection arrangement 1, monitoring a first area, may further being configured to wirelessly receive an indication of detected smoke, gas and/or moisture from another detection arrangement 1′, monitoring a second, different area. This may be particularly advantageous when the first detection arrangement 1 is positioned in a first building close to the second detection arrangement 1′ in a second building.

The control unit 6 may then further being configured to sound an alarm in its monitored area through the siren device 8 after receiving an indication of detected smoke, gas and/or moisture from the another detection arrangement 1′ monitoring a different area. This is preferably indicated in the alarm, by different signals of by spoken messages, or a combination thereof.

The different detection arrangements 1 and 1′ may be connected to each other through an application program in the smartphone, in dependence on how close each respective geographical position is compared to the geographical position of the other. When the geographical distance between the detection arrangements are below a certain threshold, e.g. 100 m, they are connected to each other.

An alarm message may be sent to a contact list, which e.g. may be controlled/updated through a web interface or an application program in the smartphone.

The message may further comprise an identification of the detection arrangement 1. This may be advantageous when the receiver of the message has multiple detection arrangements positioned in different premises/places. The smartphone/unit may be used to control the detection arrangement 1, e.g. to provide it with a suitable identification name/number. Multiple detection arrangements may send messages to each other through a common smartphone/unit. This may be used in a residential area with attached or semi-attached houses.

The smartphone/unit may be provided with a sketch of the house/apartment the detection arrangement is positioned in, and possibly further how many persons that are living therein. Further details may be provided, such as of who lives in a respective room. Alternatively, the detection arrangement may be provided with such information, and include it in an alarm message. This kind of information may provide a fire fighter with information that may save lives.

The smartphone/unit may further be used to set a reminder for the detection arrangement 1, such that the detection arrangement sounds a signal or an alarm. A timer may e.g. be set before a regular bed time, which may be used to remind a resident to check lights, candles, kitchen-range, boiler etc before going to bed for the night. A timer may be set in the morning for a similar check before leaving the premises. The smartphone/unit may be used to control the detection arrangements, such as to set different sensitivity levels for the different sensors, i.e. smoke, gas and moisture. The smartphone/unit may be configured to require a confirmation of a received alarm message. If a confirmation is not provided, the smartphone/unit may be configured to forward the alarm message to a contact network.

The detection arrangement 1 is preferably driven by a battery, to facilitate installation on suitable places of a premise. This further facilitates change of installation place for the detection arrangement.

For a detection arrangement provided with a transceiver, the control unit 6 is preferably configured to only intermittently receive/poll indications from other detection arrangements to prolong battery life.

The components of a detection arrangement 1 are illustrated in Fig 3. All components are within the housing 3. The detector device 4 is connected to the control unit 6, to be able to provide the control unit 6 with information of when a monitored smoke/gas/moisture is detected. The positioning device 5 is connected to the control unit 6, to be able to provide the control unit 6 with a geographical position, preferably upon request only to minimize energy consumption. The wireless communication device 7 is connected to the control unit 6, for the control unit 6 to be able to communicate wirelessly with similar detection arrangements 1′ and/or with a coordinating smartphone. The siren device 8 is connected to the control unit 6, to receive instructions to sound alarms/reminders/voice messages.

Computer implementations of functions of the control unit 6 are illustrated in FIG. 4.

A detect manager 30 is configured to receive indication of a detection from the detector device 4, alternatively configured to poll the detector device 4 for signal levels indicating current detected levels of smoke and/or gas and/or moisture.

A determine manager 31 is configured to determine when an alarm message is to be transmitted, based on indications received from the detector device 4. The determine manager 32 is then configured to determine a geographical position received from the positioning device 5.

A transmit manager 32 is configured to compose a message to be send to and/or to receive a messages from a smartphone/unit and/or a similar detection arrangement, through the wireless communication device 7.

An alarm manager 33 is configured to activate the siren device 8 when the determine manager has determined that an alarm message is to be transmitted. The alarm manager 33 is further configured to adapt the signal/voice message of the detection arrangement in dependent on detected smoke/gas/moisture and/or monitored area.

A method for detection of smoke, gas and moisture in a monitored area is presented. The method comprises the following steps: detecting 10 smoke or gas or moisture present in the monitored area; determining ii a geographical position of the monitored area; and transmitting 12 a message through wireless communication when smoke and/or gas and/or moisture has been detected in the monitored area. The message comprises the geographical position of the monitored area and information of what has been detected, i.e. smoke and/or gas and/or moisture.

The method may further comprise the step of activating 13 a siren device in the monitored area when smoke and/or gas and/or moisture has been detected in the monitored area.

The method may comprising the further steps: receiving a message through wireless communication when smoke and/or gas and/or moisture has been detected in a different area, wherein the message comprises a geographical position of the different area and information of what has been detected; and activating 13 a siren device in the monitored area when smoke and/or gas and/or moisture has been detected in the different area.

The invention has mainly been described above with reference to a few embodiments. However, as is readily appreciated by a person skilled in the art, other embodiments than the ones disclosed above are equally possible within the scope of the invention, as defined by the appended patent claims.

1. An alarm system comprising a cellular communication device, such as a smartphone/unit, and at least two detection arrangements,
each detection arrangement, of the at least two detection arrangements, comprising:
a housing;
a detector device arranged in said housing, said detector device comprising a smoke detector and a gas detector and a moisture detector;
a positioning device arranged in said housing;
a control unit arranged in said housing; and
a wireless communication device arranged in said housing;
wherein said detector device being configured to provide said control unit with an indication of when smoke or gas or moisture has been detected, said positioning device being configured to provide said control unit with a geographical position of said detection arrangement, and said control unit being configured to transmit a message wirelessly through said wireless communication device to said cellular communication device after receiving an indication from said detector device when smoke or gas or moisture has been detected thereof, wherein said message comprises said geographical position and information of what has been detected;
wherein each detection arrangement is arranged to monitor an area different from areas monitored by other detection arrangements; and
said cellular communication device is configured to receive said alarm message transmitted from a detection arrangement and to notify a user of said cellular communication device of said alarm message.

2. The alarm system according to claim 1, wherein said detector device comprises a smoke sensor, a gas sensor and a moisture sensor.

3. The alarm system according to claim 1, wherein said positioning device comprises a Global Positioning System (GPS) receiver, a Global Navigation Satellite System (GLONASS) receiver, a Galileo Positioning System receiver, an Indian Regional Navigation Satellite System receiver or a Beidou Navigation Satellite System receiver.

4. The alarm system according to claim 1, wherein said control unit comprises a processor and a memory.

5. The alarm system according to claim 1, further comprising a siren device arranged in said housing, wherein said control unit further being configured to sound an alarm in said monitored area through said siren device after receiving an indication from said detector device when smoke or gas or moisture has been detected thereof.

6. The alarm system according to claim 5, wherein said siren device comprises a speaker for sounding said alarm.

7. The alarm system according to claim 1, wherein said wireless communication device comprises a transceiver for a cellular or mobile network.

8. The alarm system according to claim 1, wherein said control unit further being configured to wirelessly receive an indication of detected smoke, gas or moisture from another detection arrangement monitoring a different area.

9. The alarm system according to claim 8, wherein said control unit further being configured to sound an alarm in said monitored area through said siren device after receiving an indication of detected smoke, gas or moisture from said another detection arrangement monitoring a different area.

10. The alarm system according to claim 1, wherein said message further comprises an identification of said detection arrangement.
